(19) United States
(12) Patent Application Publication
(10) Pub. No.: US 2025/0286129 A1
(43) Pub. Date: Sep. 11, 2025

(54) ELECTROLYTE FOR RECHARGEABLE LITHIUM BATTERY AND RECHARGEABLE LITHIUM BATTERY INCLUDING THE SAME

(71) Applicant: SAMSUNG SDI CO., LTD., Yongin-si (KR)

(72) Inventors: Seunghyeon SON, Yongin-si (KR); TAE HYON BAE, Yongin-si (KR); Harim LEE, Yongin-si (KR); Sanghyung KIM, Yongin-si (KR); SUNDAE KIM, Yongin-si (KR); Yeji YANG, Yongin-si (KR); Sangheon LEE, Yongin-si (KR); CHEONSOO KIM, Yongin-si (KR)

(21) Appl. No.: 18/805,267

(22) Filed: Aug. 14, 2024

(30) Foreign Application Priority Data
Mar. 8, 2024 (KR) 10-2024-0033408

(51) Int. Cl. H01M 10/0567; H01M 10/052; H01M 10/0569; H01M 50/105

(52) U.S. Cl. CPC H01M 10/0567; H01M 10/052; H01M 10/0569; H01M 50/105

(57) ABSTRACT

An electrolyte and a rechargeable lithium battery including the electrolyte are provided. The electrolyte includes a lithium salt, a non-aqueous organic solvent, and an additive. The non-aqueous organic solvent includes a compound represented by Chemical Formula 1. The additive may include a compound represented by Chemical Formula 2.

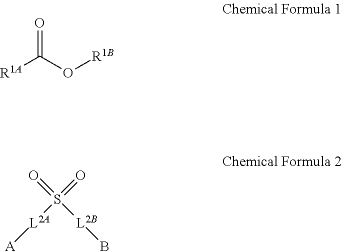

### CROSS-REFERENCE TO RELATED APPLICATION

The present application claims priority to and the benefit of Korean Patent Application No. 10-2024-0033408, filed on Mar. 8, 2024, in the Korean Intellectual Property Office, the entire content of which is incorporated herein by reference.

### BACKGROUND

### 1. Field

One or more embodiments of the present disclosure relates to an electrolyte for a rechargeable lithium battery and a rechargeable lithium battery including the electrolyte.

### 2. Description of the Related Art

Recently, with the rapid spread and popularization of battery-using electronic devices, such as mobile phones, laptop computers, and/or electric vehicles, there is a rapidly increasing demand or desire for rechargeable batteries with relatively high energy density and high capacity. Therefore, intensive research has been conducted to improve performance of rechargeable batteries, such as rechargeable lithium batteries.

A rechargeable lithium battery includes a positive electrode, a negative electrode, and an electrolyte. The positive and negative electrodes (each) include an active material capable of intercalating and deintercalating of lithium ions, and electrical energy is generated due to oxidation and reduction reactions when lithium ions are intercalated and deintercalated.

### SUMMARY

One or more aspects of embodiments of the present disclosure are directed toward an electrolyte capable of improving high-temperature characteristics of a rechargeable lithium battery.

One or more aspects of embodiments of the present disclosure are directed toward a rechargeable lithium battery including the electrolyte and having desired high-temperature characteristics at high-voltage environment.

Additional aspects will be set forth in part in the description which follows and, in part, will be apparent from the description, or may be learned by practice of the presented embodiments of the disclosure.

According to one or more embodiments of the present disclosure, an electrolyte for a rechargeable lithium battery may include: a lithium salt; a non-aqueous organic solvent; and an additive.

The non-aqueous organic solvent may include a compound represented by Chemical Formula 1.

The additive may include a compound represented by Chemical Formula 2.

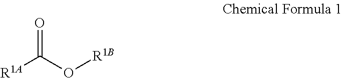

In Chemical Formula 1, R^{1A} and R^{1B} may each independently be hydrogen, a halogen, a substituted or unsubstituted C1 to C10 alkyl group, or a substituted or unsubstituted C3 to C10 cycloalkyl group.

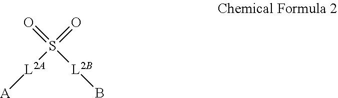

In Chemical Formula 2, L^{2A} and L^{2B} may each independently be a single bond, a substituted or unsubstituted C1 to C5 alkylene group, a substituted or unsubstituted C2 to C5 alkenylene group, a substituted or unsubstituted C2 to C5 alkynylene group, or a substituted or unsubstituted C6 to C20 arylene group.

In Chemical Formula 2, A and B may each independently be a substituted or unsubstituted C1 to C20 alkyl group, a substituted or unsubstituted C6 to C20 aryl group, or a substituted or unsubstituted C2 to C20 heteroaryl group.

In Chemical Formula 2, at least one selected from among A and B may be a group represented by Chemical Formula A.

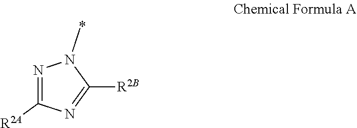

In Chemical Formula A, R^{2A} and R^{2B} may each independently be hydrogen, a halogen, a substituted or unsubstituted C1 to C10 alkyl group, or a substituted or

According to one or more embodiments of the present disclosure, a rechargeable lithium battery may include: a positive electrode that includes a positive electrode active material; a negative electrode that includes a negative electrode active material; and the aforementioned electrolyte.

### BRIEF DESCRIPTION OF DRAWINGS

The above and other aspects, features, and advantages of certain embodiments of the present disclosure will be more apparent from the following description taken in conjunction with the accompanying drawings.

FIG. 1 illustrates a simplified conceptual diagram showing a rechargeable lithium battery according to one or more embodiments of the present disclosure.

FIGS. 2-5 each illustrate a simplified cross-sectional view showing a rechargeable lithium battery according to one or more embodiments of the present disclosure.

### DETAILED DESCRIPTION

In order to sufficiently understand the configurations and aspects of the present disclosure, one or more embodiments of the disclosure will be described with reference to the accompanying drawings. It should be noted, however, that the present disclosure is not limited to the following example embodiments, and may be implemented in one or more suitable forms. Rather, the example embodiments are provided only to illustrate the present disclosure and let those skilled in the art fully know the scope of the disclosure.

In the present disclosure, it will be understood that, if (e.g., when) an element is referred to as being on another element, the element may be directly on the other element or intervening elements may be present therebetween. In contrast, if (e.g., when) an element is referred to as being “directly on” another element, there are no intervening elements present. In the drawings, thicknesses of some components may be exaggerated for effectively explaining the technical contents. Like reference numerals refer to like elements throughout the present disclosure, and duplicative descriptions thereof may not be provided for conciseness.

Unless otherwise specially noted in the present disclosure, the singular forms “a,” “an,” and “the” are intended to include the plural forms as well, unless the context clearly indicates otherwise. Further, the utilization of “may” when describing embodiments of the present disclosure refers to “one or more embodiments of the present disclosure”. In addition, unless otherwise specially noted, the phrase “A or B” or “A and/or B” or “A/B” may indicate “A but not B”, “B but not A”, and “A and B”. The terms “comprises/includes” and/or “comprising/including” used in the present disclosure do not exclude the presence or addition of one or more other components.

As used herein, the term “combination thereof” may refer to a mixture, a stack, a composite, a copolymer, an alloy, a blend, or a reaction product of the constituents.

Unless otherwise especially defined in this description, a particle diameter may be an average particle diameter. In addition, a particle diameter indicates an average particle diameter (D50) where a cumulative volume is about 50 volume % in a particle size distribution. The average particle diameter (D50) may be measured by a method widely suitable to those skilled in the art, for example, by a particle size analyzer, for example, HORIBA, LA-950 laser particle size analyzer, a transmission electron microscope (TEM), or a scanning electron microscope (SEM). In one or more embodiments, a dynamic light-scattering measurement device is used to perform a data analysis, the number of particles is counted for each particle size range, and then from the data, an average particle diameter (D50) value may be obtained through a calculation. In some embodiments, a laser scattering method may be utilized to measure the average particle diameter (D50). In the laser scattering method, target particles are distributed in a distribution solvent, introduced into a laser scattering particle measurement device (e.g., MT3000 commercially available from Microtrac, Inc), irradiated with ultrasonic waves of 28 kHz at a power of 60 W, and then an average particle diameter (D50) is calculated in the 50% standard of particle diameter distribution in the measurement device. D50 refers to the average diameter (or size) of particles whose cumulative volume corresponds to 50 vol % in the particle size distribution (e.g., cumulative distribution), and refers to the value of the particle size corresponding to 50% from the smallest particle when the total number of particles is 100% in the distribution curve accumulated in the order of the smallest particle size to the largest particle size. In the present disclosure, when particles are spherical, “diameter” indicates an average particle diameter, and when the particles are non-spherical, the “diameter” indicates a major axis length.

In the present disclosure, unless otherwise separately defined, the term “substituted” may refer to that at least one hydrogen of a substituent or a compound is substituted by deuterium, a halogen, a hydroxyl group, an amino group, a C1 to C30 amine group, a nitro group, a C1 to C40 silyl group, a C1 to C30 alkyl group, a C1 to C10 alkylsilyl group, a C6 to C30 arylsilyl group, a C3 to C30 cycloalkyl group, a C3 to C30 heterocycloalkyl group, a C6 to C30 aryl group, a C2 to C30 heteroaryl group, C1 to C20 alkoxy group, a C1 to C10 fluoroalkyl group, a cyano group, or a (e.g., any suitable) combination thereof.

For example, in one or more embodiments, the term “substituted” may refer to that at least one hydrogen of a substituent or a compound is substituted by deuterium, a halogen, a C1 to C30 alkyl group, a C1 to C10 alkylsilyl group, a C6 to C30 arylsilyl group, a C3 to C30 cycloalkyl group, a C3 to C30 heterocycloalkyl group, a C6 to C30 aryl group, a C2 to C30 heteroaryl group, a C1 to C10 fluoroalkyl group, or a cyano group. In one or more embodiments, the term “substituted” may refer to that at least one hydrogen of a substituent or a compound is substituted by deuterium, a halogen, a C1 to C20 alkyl group, a C6 to C30 aryl group, a C1 to C10 fluoroalkyl group, or a cyano group. In one or more embodiments, the term “substituted” may refer to that at least one hydrogen of a substituent or a compound is substituted by deuterium, a halogen, a C1 to C5 alkyl group, a C6 to C18 aryl group, a C1 to C5 fluoroalkyl group, or a cyano group. In one or more embodiments, the term “substituted” may refer to that at least one hydrogen of a substituent or a compound is substituted by deuterium, a cyano group, a halogen, a methyl group, an ethyl group, a propyl group, a butyl group, a phenyl group, a biphenyl group, a terphenyl group, a trifluoromethyl group, or a naphthyl group.

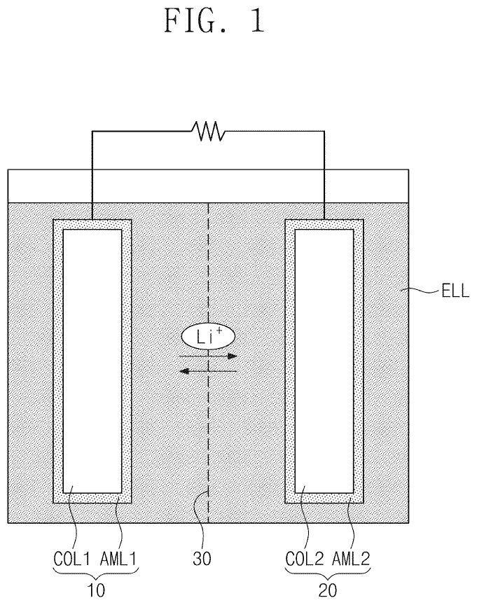

FIG. 1 illustrates a simplified conceptual diagram showing a rechargeable lithium battery according to one or more embodiments of the present disclosure. Referring to FIG. 1, a rechargeable lithium battery may include a positive electrode 10, a negative electrode 20, a separator 30, and an electrolyte ELL.

The positive electrode 10 and the negative electrode 20 may be spaced and/or apart (e.g., spaced apart or separated) from each other across the separator 30. The separator 30 may be arranged between the positive electrode 10 and the negative electrode 20. The positive electrode 10, the negative electrode 20, and the separator 30 may be in contact with the electrolyte ELL. For example, the positive electrode 10, the negative electrode 20, and the separator 30 may be impregnated in and/or with the electrolyte ELL.

The electrolyte ELL may be a medium through which lithium ions are migrated and transferred between the positive electrode 10 and the negative electrode 20. In the electrolyte ELL, the lithium ions may move through the separator 30 toward one of (e.g., selected from among) the positive electrode 10 and the negative electrode 20.

### Positive Electrode 10

The positive electrode 10 for a rechargeable lithium battery may include a current collector COL1 and a positive electrode active material layer AML1 formed on the current collector COL1. The positive electrode active material layer AML1 may include a positive electrode active material (e.g., in a form of particles) and may further include a binder and/or a conductive material (e.g., electron conductor).

For example, in some embodiments, the positive electrode 10 may further include an additive that may serve as a sacrificial positive electrode.

An amount of the positive electrode active material may be in a range of about 90 wt % to about 99.5 wt % based on 100 wt % of a total weight of the positive electrode active material layer AML1. Amounts of the binder and the conductive material may each be about 0.5 wt % to about 5 wt % based on 100 wt % of the total weight of the positive electrode active material layer AML1.

The binder may serve to improve attachment of positive electrode active material particles to each other and also to improve attachment of the positive electrode active material to the current collector COL1. The binder may include, for example, one or more selected from among polyvinyl alcohol, carboxymethyl cellulose, hydroxypropyl cellulose, diacetyl cellulose, polyvinylchloride, carboxylated polyvinylchloride, polyvinylfluoride, an ethylene oxide-containing polymer, polyvinylpyrrolidone, polyurethane, polytetrafluoroethylene, polyvinylidene fluoride, polyethylene, polypropylene, a styrene-butadiene rubber, a (meth)acrylated styrene-butadiene rubber, an epoxy resin, a (meth)acrylic resin, a polyester resin, and nylon, but embodiments of the present disclosure are not limited thereto.

The conductive material (e.g., an electrically or electron conductive material) may be used to provide an electrode with conductivity, and any suitable conductive material without causing chemical change of a battery may be used as the conductive material to constitute the battery. The conductive material may include, for example, a carbon-based material such as natural graphite, artificial graphite, carbon black, acetylene black, Ketjen black, carbon fiber, carbon nano-fiber, and/or carbon nano-tube; a metal powder or metal fiber containing one or more of (e.g., selected from among) copper, nickel, aluminum, and silver; a conductive polymer such as a polyphenylene derivative; and/or a (e.g., any suitable) mixture (e.g., combination) thereof.

In one or more embodiments, aluminum (Al) may be used as the current collector COL1, but embodiments of the present disclosure are not limited thereto.

### Positive Electrode Active Material

The positive electrode active material in the positive electrode active material layer AML1 may include a compound (e.g., lithiated intercalation compound) that may reversibly intercalate and deintercalate lithium. For example, in one or more embodiments, the positive electrode active material may include at least one kind of composite oxide including lithium and a metal that is selected from among cobalt, manganese, nickel, and/or a (e.g., any suitable) combination thereof.

The composite oxide may include lithium transition metal composite oxides, for example, lithium-nickel-based oxides, lithium-cobalt-based oxides, lithium-manganese-based oxides, lithium-iron-phosphate-based compounds, cobalt-free nickel-manganese-based oxides, and/or a (e.g., any suitable) combination thereof.

For example, in one or more embodiments, the positive electrode active

material may include a compound represented by one selected from among chemical formulae: LiₐA_{1-b}X_{b}O_{2-c}D_{c} (0.90≤a≤1.8, 0≤b≤0.5, 0≤c≤0.05); LiₐMn_{2-b}X₆O_{4-c}D_{c} (0.90≤a≤1.8, 0≤b≤0.5, 0≤c≤0.05); LiₐNi_{1-b-c}CO_{b}X_{c}O_{2-α}D_{α} (0.90≤a≤1.8, 0≤b≤0.5, 0≤c≤0.5, 0<α<2); LiₐNi_{1-b-c}Mn_{b}X_{c}O_{2-α}D_{α} (0.90≤a≤1.8, 0≤b≤0.5, 0≤c≤0.5, 0<α<2); LiₐNi_{b}Co_{c}L¹_{d}GₑO₂ (0.90≤a≤1.8, 0≤b≤0.9, 0≤c≤0.5, 0≤d≤0.5, 0≤e≤0.1); LiₐNiG_{b}O₂(0.90≤a≤1.8, 0.001≤b≤0.1); LiₐCoG_{b}O₂ (0.90≤a≤1.8, 0.001≤b≤0.1); LiₐMn_{1-b}G_{b}O₂ (0.90≤a≤1.8, 0.001≤b≤0.1); LiₐMn₂G_{b}O₄ (0.90≤a≤1.8, 0.001≤b≤0.1); LiₐMn_{1-g}G_{g}PO₄ (0.90≤a≤1.8, 0≤g≤0.5); Li_{(3-f)}Fe₂(PO₄)₃ (0≤f≤2); and LiₐFePO₄ (0.90≤a≤1.8).

In the foregoing chemical formulae, A may be nickel (Ni), cobalt (Co), manganese (Mn), and/or a (e.g., any suitable) combination thereof, X may be Al, Ni, Co, Mn, chromium (Cr), iron (Fe), magnesium (Mg), strontium (Sr), vanadium (V), a rare-earth element, and/or a (e.g., any suitable) combination thereof, D may be oxygen (O), fluorine (F), sulfur(S), phosphorous (P), and/or a (e.g., any suitable) combination thereof, G may be Al, Cr, Mn, Fe, Mg, lanthanum (La), cerium (Ce), Sr, V, and/or a (e.g., any suitable) combination thereof, and L1 is Mn, Al, and/or a (e.g., any suitable) combination thereof.

For example, in one or more embodiments, the positive electrode active material may be a high nickel-based positive electrode active material having a nickel content (e.g., amount) of equal to or greater than about 80 mol %, equal to or greater than about 85 mol %, equal to or greater than about 90 mol %, equal to or greater than about 91 mol %, or equal to or greater than about 94 mol % and equal to or less than about 99 mol % based on 100 mol % of a total metal excluding lithium in the lithium transition metal composite oxide. The high nickel-based positive electrode active material may achieve high capacity and thus may be applied to a high-capacity and high-density rechargeable lithium battery.

### Negative Electrode 20

The negative electrode 20 for a rechargeable lithium battery may include a current collector COL2 and a negative electrode active material layer AML2 positioned on the current collector COL2. The negative electrode active material layer AML2 may include a negative electrode active material (e.g., in a form of particles) and may further include a binder and/or a conductive material (e.g., electron conductor).

For example, in one or more embodiments, the negative electrode active material layer AML2 may include a negative electrode active material of about 90 wt % to about 99 wt %, a binder of about 0.5 wt % to about 5 wt %, and a conductive material of about 0 wt % to about 5 wt %, based on 100 wt % of a total weight of the negative electrode active material layer.

The binder may serve to improve attachment of negative electrode active material particles to each other and also to improve attachment of the negative electrode active material to the current collector COL2. The binder may include a non-aqueous (e.g., water-insoluble) binder, an aqueous (e.g., water-soluble) binder, a dry binder, and/or a (e.g., any suitable) combination thereof.

The non-aqueous binder may include polyvinyl chloride, carboxylated polyvinyl chloride, polyvinyl fluoride, an ethylene propylene copolymer, polystyrene, polyurethane, polytetrafluoroethylene, polyvinylidene fluoride, polyethylene, polypropylene, polyamide imide, polyimide, and/or a (e.g., any suitable) combination thereof.

The aqueous binder may include a styrene-butadiene rubber, a (meth)acrylated styrene-butadiene rubber, a (meth)acrylic rubber, a butyl rubber, a fluoro elastomer, polyethylene oxide, polyvinyl pyrrolidone, polyepichlorohydrin, polyphosphazene, poly(meth)acrylonitrile, an ethylene propylene diene copolymer, polyvinyl pyridine, chlorosulfonated polyethylene, latex, a polyester resin, a (meth)acrylic resin, a phenolic resin, an epoxy resin, polyvinyl alcohol, and/or a (e.g., any suitable) combination thereof.

When an aqueous binder is used as the binder of the negative electrode, a cellulose-based compound capable of providing viscosity may further be included. The cellulose-based compound may include one or more selected from among carboxymethyl cellulose, hydroxypropylmethyl cellulose, methyl cellulose, and alkali metal salts thereof. The alkali metal may include Na, K, or Li.

The dry binder may include a fibrillizable polymer material, for example, polytetrafluoroethylene, polyvinylidene fluoride, a polyvinylidene fluoride-hexafluoropropylene copolymer, polyethylene oxide, and/or a (e.g., any suitable) combination thereof.

The conductive material (e.g., electrically or electron conductive material) may be used to provide an electrode with conductivity, and any suitable conductive material without causing chemical change of a battery may be used as the conductive material to constitute the battery. For example, in one or more embodiments, the conductive material may include a carbon-based material such as natural graphite, artificial graphite, carbon black, acetylene black, Ketjen black, carbon fiber, carbon nano-fiber, and/or carbon nano-tube; a metal powder or metal fiber including one or more selected from among copper, nickel, aluminum, and silver; a conductive polymer such as a polyphenylene derivative; and/or a (e.g., any suitable) mixture thereof.

The current collector COL2 may include a copper foil, a nickel foil, a stainless-steel foil, a titanium foil, a nickel foam, a copper foam, a polymer substrate coated with a conductive metal, and/or a (e.g., any suitable) combination thereof.

### Negative Electrode Active Material

The negative electrode active material in the negative electrode active material layer AML2 may include a material that may reversibly intercalate and deintercalate lithium ions, lithium metal, a lithium metal alloy, a material that may dope and de-dope lithium, or a transition metal oxide.

The material that may reversibly intercalate and deintercalate lithium ions may include a carbon-based negative electrode active material, for example, crystalline carbon, amorphous carbon, and/or a (e.g., any suitable) combination thereof. For example, the crystalline carbon may include graphite such as non-shaped (e.g., irregularly shaped), sheet-shaped, flake-shaped, sphere-shaped, or fiber-shaped natural graphite and/or artificial graphite, and the amorphous carbon may include soft carbon, hard carbon, mesophase pitch carbon, and/or calcined coke.

The lithium metal alloy may include an alloy of lithium and a metal that is selected from among sodium (Na), potassium (K), rubidium (Rb), cesium (Cs), francium (Fr), beryllium (Be), magnesium (Mg), calcium (Ca), strontium (Sr), silicon (Si), antimony (Sb), lead (Pb), indium (In), zinc (Zn), barium (Ba), radium (Ra), germanium (Ge), aluminum (Al), and tin (Sn).

The material that may dope and de-dope lithium may include a Si-based negative electrode active material or a Sn-based negative electrode active material. The Si-based negative electrode active material may include silicon, a silicon-carbon composite, SiOₓ (0<x≤2), Si-Q alloy (where Q is an alkali metal, an alkaline earth metal, a Group 13 element, a Group 14 element (except for Si), a Group 15 element, a Group 16 element, a transition metal, a rare-earth element, and/or a (e.g., any suitable) combination thereof), and/or a (e.g., any suitable) combination thereof. The Sn-based negative electrode active material may include Sn, SnOₖ (0<k≤2) (e.g., SnO₂), a Sn-based alloy, or a (e.g., any suitable) combination thereof.

The silicon-carbon composite may be a composite of silicon and amorphous carbon (e.g., in a form of particles). According to one or more embodiments, the silicon-carbon composite may have a structure in which the amorphous carbon is coated on a surface of each of silicon particles. For example, in one or more embodiments, the silicon-carbon composite may include a secondary particle (core) in which primary silicon particles are assembled, and an amorphous carbon coating layer (shell) on (e.g., positioned on) a surface of the secondary particle. The amorphous carbon may also be positioned between the primary silicon particles, and for example, the primary silicon particles may be coated with the amorphous carbon. The secondary particles may be present dispersed in an amorphous carbon matrix.

In one or more embodiments, the silicon-carbon composite may further include crystalline carbon. For example, the silicon-carbon composite may include a core including crystalline carbon and silicon particles and may also include an amorphous carbon coating layer positioned on a surface of the core.

In one or more embodiments, the Si-based negative electrode active material and/or the Sn-based negative electrode active material may be used in combination with a carbon-based negative electrode active material.

### Separator 30

Based on type or kind of the rechargeable lithium battery, the separator 30 may be present between the positive electrode 10 and the negative electrode 20. The separator 30 may include one or more selected from among polyethylene, polypropylene, and polyvinylidene fluoride, or may have a multi-layered separator thereof such as a polyethylene/polypropylene bi-layered separator, a polyethylene/polypropylene/polyethylene tri-layered separator, or a polypropylene/polyethylene/polypropylene tri-layered separator.

The separator 30 may include a porous substrate and a coating layer positioned on a surface (e.g., one surface or two opposite surfaces) of the porous substrate, and the coating layer may include an organic material, an inorganic material, and/or a (e.g., any suitable) combination thereof.

The porous substrate may be a polymer layer including one selected from among polyolefin such as polyethylene and polypropylene, polyester such as polyethylene terephthalate and polybutylene terephthalate, polyacetal, polyamide, polyimide, polycarbonate, polyetherketone, polyaryletherketone, polyetherimide, polyamideimide, polybenzimidazole, polyethersulfone, polyphenyleneoxide, a cyclic olefin copolymer, polyphenylenesulphide, polyethylene naphthalate, a glass fiber, and polytetrafluoroethylene (e.g., Teflon), or may be a copolymer or a mixture including two or more thereof.

The organic material may include a polyvinylidenefluoride-based copolymer and/or a (meth)acrylic copolymer.

The inorganic material may include an inorganic particle selected from among Al₂O₃, SiO₂, TiO₂, SnO₂, CeO₂, MgO, NiO, CaO, GaO, ZnO, ZrO₂, Y₂O₃, SrTiO₃, BaTiO₃, Mg (OH)₂, Boehmite, and/or a (e.g., any suitable) combination thereof, but embodiments of the present disclosure are not limited thereto.

In one or more embodiments, the organic material and the inorganic material may be present mixed in one coating layer or may be present as a stack of a coating layer including the organic material and a coating layer including an inorganic material.

### Electrolyte ELL

The electrolyte ELL for a rechargeable lithium battery may include a non-aqueous organic solvent, a lithium salt, and an additive.

The following will describe a non-aqueous organic solvent according to one or more embodiments of the present disclosure.

The non-aqueous organic solvent may serve as a medium for transmitting ions that participate in an electrochemical reaction of a battery.

The non-aqueous organic solvent may include an ester-based solvent, a carbonate-based solvent, an ether-based solvent, a ketone-based solvent, an alcohol-based solvent, an aprotic solvent, and/or a (e.g., any suitable) combination thereof.

In one or more embodiments, the non-aqueous organic solvent may include an ester-based solvent and a carbonate-based solvent.

The ester-based solvent and the carbonate-based solvent may be mixed in a volume ratio of about 1:1 to about 9:1. For example, the ester-based solvent and the carbonate-based solvent may be mixed in a volume ratio of about 1:1 to about 6:1, about 1:1 to about 4:1, or about 2:1 to about 4:1.

The ester-based solvent according to one or more embodiments of the present disclosure may include a compound represented by Chemical Formula 1.

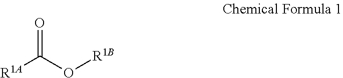

In Chemical Formula 1, R^{1A} and R^{1B} may each independently be hydrogen, a halogen, a substituted or unsubstituted C1 to C10 alkyl group, or a substituted or unsubstituted C3 to C10 cycloalkyl group.

In one or more embodiments, R^{1A} may be a substituted or unsubstituted C3 to C10 alkyl group.

In one or more embodiments, R^{1A} may be a substituted or unsubstituted C3 alkyl group.

In one or more embodiments, R^{1A} may be an unsubstituted C3 alkyl group.

In one or more embodiments, R^{1B} may be a substituted or unsubstituted C1 to C2 alkyl group.

In one or more embodiments, R^{1B} may be a substituted or unsubstituted C2 alkyl group.

In one or more embodiments, R^{1B} may be an unsubstituted C2 alkyl group.

The compound represented by Chemical Formula 1 may be included in an amount of about 50 vol % to about 95 vol % relative to a total volume of 100 vol % of the electrolyte for the rechargeable lithium battery. For example, in one or more embodiments, the compound may be included in an amount of about 60 vol % to about 95 vol % or about 70 vol % to about 80 vol % relative to the total volume of 100 vol % of the electrolyte for the rechargeable lithium battery. In the amount range as described above, a stable film may be formed on an electrode surface even in a high-temperature and high-voltage environment, and a film having an appropriate or suitable thickness may be formed on an electrode surface to prevent or reduce a resistance increase in a high-temperature and high-voltage environment, thereby achieving a rechargeable lithium battery with improved lifetime and output characteristics.

The ester-based solvent according to one or more embodiments of the present disclosure may include methyl acetate, ethyl acetate, n-propyl acetate, dimethyl acetate, methyl propionate (MP), ethyl propionate (EP), propyl propionate (PP), methyl butyrate, ethyl butyrate (EB), propyl butyrate, decanolide, mevalonolactone, valerolactone, and/or caprolactone.

The carbonate-based solvent according to one or more embodiments of the present disclosure may include dimethyl carbonate (DMC), diethyl carbonate (DEC), dipropyl carbonate (DPC), methylpropyl carbonate (MPC), ethylpropyl carbonate (EPC), ethylmethyl carbonate (EMC), ethylene carbonate (EC), propylene carbonate (PC), and/or butylene carbonate (BC).

The carbonate-based solvent according to one or more embodiments of the present disclosure may include ethylene carbonate (EC) and propylene carbonate (PC).

The ethylene carbonate (EC) and the propylene carbonate (PC) may be mixed in a volume ratio of about 1:1 to about 1:9. For example, in one or more embodiments, the ethylene carbonate (EC) and the propylene carbonate (PC) may be mixed in a volume ratio of about 1:1 to about 1:5, about 1:1 to about 1:3, or about 1:1 to about 1:1.5.

The ether-based solvent may include dibutyl ether, tetraglyme, diglyme, dimethoxyethane, 2-methyltetrahydrofuran, 2.5-dimethyltetrahydrofuran, and/or tetrahydrofuran. The ketone-based solvent may include cyclohexanone. The alcohol-based solvent may include ethyl alcohol and/or isopropyl alcohol. The aprotic solvent may include nitriles such as R—CN (where R is a hydrocarbon group having a C2 to C20 linear, branched, or cyclic structure and may include a double bond, an aromatic ring, or an ether group); amides such as dimethylformamide; dioxolanes such as 1,3-dioxolane and/or 1,4-dioxolane; and/or sulfolanes.

The non-aqueous organic solvent may be used alone or in a mixture of two or more thereof.

In addition, if (e.g., when) a carbonate-based solvent is used, a cyclic carbonate and a chain carbonate may be mixed and used, and the cyclic carbonate and the chain carbonate may be mixed in a volume ratio of about 1:1 to about 1:9.

The lithium salt may be a material that is dissolved in the non-aqueous organic solvent to serve as a supply source of lithium ions in a rechargeable lithium battery and plays a role in enabling a basic operation of the rechargeable lithium battery and in promoting the movement of lithium ions between the positive electrode and the negative electrode. The lithium salt may include, for example, at least one selected from among LiPF₆, LiBF₄, LiSbF₆, LiAsF₆, LiClO₄, LiAlO₂, LiAlCl₄, LiPO₂F₂, LiCl, LiI, LiN(SO₃C₂F₅)₂, Li(FSO₂)₂N, lithium bis(fluorosulfonyl)imide (LiFSI), LiC₄F₉SO₃, LiN(CₓF₂ₓ₊₁SO₂) (C_{y}F_{2y+1}SO₂) (where x and y are integers between 1 to 20), lithium trifluoromethane sulfonate, lithium tetrafluoroethanesulfonate, lithium difluorobis (oxalato) phosphate (LiDFOP), and lithium bis (oxalato) borate (LiBOB)

The following will describe an additive for the electrolyte according to one or more embodiments.

The additive according to one or more embodiments of disclosure may include a compound represented by Chemical Formula 2.

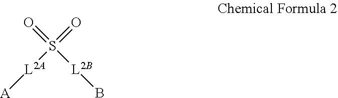

In Chemical Formula 2, L^{2A} and L^{2B} may each independently be a single bond, a substituted or unsubstituted C1 to C5 alkylene group, a substituted or unsubstituted C2 to C5 alkenylene group, a substituted or unsubstituted C2 to C5 alkynylene group, or a substituted or unsubstituted C6 to C20 arylene group. When L^{2A} is a single bond, A may be directly connected via a single bond to S. When L^{2B} is a single bond, B may be directly connected via a single bond to S.

In Chemical Formula 2, A and B may each independently be a substituted or unsubstituted C1 to C20 alkyl group, a substituted or unsubstituted C6 to C20 aryl group, or a substituted or unsubstituted C2 to C20 heteroaryl group.

In Chemical Formula 2, at least one selected from among A and B may be a group represented by Chemical Formula A. In one or more embodiments, one selected from among A and B may be a group represented by Chemical Formula A, and the other one selected from among A and B may be a substituted or unsubstituted C1 to C20 alkyl group, a substituted or unsubstituted C6 to C20 aryl group, or a substituted or unsubstituted C2 to C20 heteroaryl group. In one or more embodiments, both (e.g., simultaneously) of A and B may (each) be a group represented by Chemical Formula A.

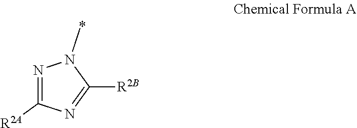

In Chemical Formula A, R^{2A} and R^{2B} may each independently be hydrogen, a halogen, a substituted or unsubstituted C1 to C10 alkyl group, or a substituted or unsubstituted C3 to C10 cycloalkyl group.

In a rechargeable lithium battery, a non-aqueous electrolyte may be decomposed during an initial charge-discharge to form a film having passivation ability on surfaces of positive and negative electrodes to improve high-temperature storage characteristics, but the film may be deteriorated due to acid such as HF⁻ and PF₅⁻ produced by thermal decomposition of lithium salts (LiPF₆ and/or the like) widely used in lithium batteries. This acid attack may elute transition metal elements from a positive electrode and increase a surface resistance of the positive electrode caused by a structural change of the surface, and a theoretical capacity may be reduced due to loss of metal elements which are redox (reduction and oxidation) centers, which may result in a reduction in capacity. In addition, the eluted transition metal ions may be electrodeposited on a negative electrode that reacts in a strong reduction potential range to not only consume electrons but also destruct the film during the electrodeposition to expose the surface of the negative electrode, thereby causing an additional electrolyte decomposition reaction. There may thus be an increase in resistance of the negative electrode and in irreversible capacity, and accordingly there may be a problem and issue of continuous reduction in cell capacity. In the present disclosure, a triazole group and a sulfone group of the compound represented by Chemical Formula 2 described above may provide an unshared electron pair to capture PF₅⁻ and stabilize a LiPF₆ salt, with the result that it may remove the acid led by decomposition of the lithium salt. For example, the compound represented by Chemical Formula 2 contains both a triazole group and a sulfone group. These groups may play a role in capturing PF₅⁻ and stabilizing a LiPF₆ salt. As a result, they may potentially help remove the acid produced during the decomposition of the lithium salt.

The sulfone group included in Chemical Formula 2 may form a film on the surface of the positive electrode to suppress or reduce decomposition of a positive electrode active material, and thus it may be possible to inhibit or reduce gas generation and dissolution of transition metal due to the decomposition of the positive electrode active material.

In addition, the compound represented by Chemical Formula 2 described herein may strengthen a solid electrolyte interface (SEI) layer on the surface of the negative electrode, while preventing or reducing deterioration of the SEI layer or dissolution of transition metals from the positive electrode during high-temperature storage.

For example, in one or more embodiments, at least one selected from among L^{2A} and L^{2B} may be a substituted or unsubstituted C1 to C5 alkylene group.

For example, in one or more embodiments, L^{2A} and L^{2B} may each independently be a substituted or unsubstituted C1 to C5 alkylene group.

For example, in one or more embodiments, at least one selected from among L^{2A} and L^{2B} may be a substituted or unsubstituted C2 to C5 alkylene group.

For example, in one or more embodiments, L^{2A} and L^{2B} may each independently be a substituted or unsubstituted C2 to C5 alkylene group.

For example, in one or more embodiments, the compound represented by Chemical Formula 2 may be represented by Chemical Formula 2-1.

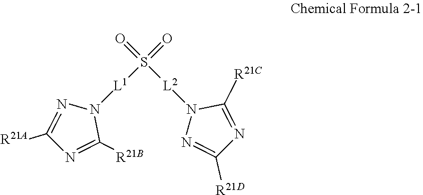

In Chemical Formula 2-1, L¹ and L² may each independently be a substituted or unsubstituted C2 to C5 alkylene group.

In Chemical Formula 2-1, R^{21A}, R^{21B}, R^{21C}, and R^{21D} may each independently be hydrogen, a halogen, a substituted or unsubstituted C1 to C10 alkyl group, or a substituted or unsubstituted C3 to C10 cycloalkyl group.

In one or more embodiments, the compound represented by Chemical Formula 2 may be selected from among compounds listed in Group 1.

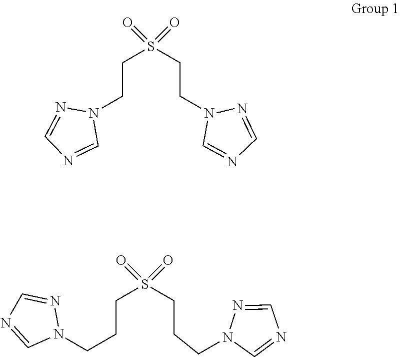 [SMILES: O=S(=O)(CCn1cncn1)CCn1cncn1 ; O=S(=O)(CCCn1cncn1)CCCn1cncn1]

The compound represented by Chemical Formula 2 may be included in an amount of about 0.1 to 10 parts by weight relative to a total 100 parts by weight of the electrolyte for the rechargeable lithium battery.

For example, in one or more embodiments, the compound represented by Chemical Formula 2 may be included in an amount of about 0.5 to 10 parts by weight, about 1 to 10 parts by weight, or about 1 to 5 parts by weight relative to the total 100 parts by weight of the electrolyte for the rechargeable lithium battery. In the amount range as described above, an increase in resistance at high temperatures may be prevented or reduced to achieve a rechargeable lithium battery with improved lifetime and output characteristics.

In one or more embodiments, the electrolyte for the rechargeable lithium battery may further include at least one other additive selected from among vinylene carbonate (VC), fluoroethylene carbonate (FEC), difluoroethylene carbonate, chloroethylene carbonate, dichloroethylene carbonate, bromoethylene carbonate, dibromoethylene carbonate, nitroethylene carbonate, cyanoethylene carbonate, vinylethylene carbonate (VEC), adiponitrile (AN), succinonitrile (SN), 1,3,6-hexane tricyanide (HTCN), propenesultone (PST), propanesultone (PS), lithium tetrafluoroborate (LiBF₄), lithium difluorophosphate (LiPO₂F₂), and 2-fluoro biphenyl (2-FBP).

The additional inclusion of the aforementioned other additive may further increase the lifetime or effectively control gas generation from the positive and negative electrodes during high-temperature storage.

The other additive may be included in an amount of about 0.2 to 20 parts by weight, for example, about 0.2 to 15 parts by weight or about 0.2 to 10 parts by weight relative to the total 100 parts by weight of the electrolyte for the rechargeable lithium battery.

When the amount of the other additive is in the range described above, an increase in film resistance may be minimized or reduced to contribute to an improvement in battery performance.

The electrolyte for the rechargeable lithium battery according to the present disclosure may include both (e.g., simultaneously) the compound represented by Chemical Formula 1 and the compound represented by Chemical Formula 2, and thus damage to the SEI layer may be prevented or reduced to improve high-temperature storage characteristics.

### Rechargeable Lithium Battery

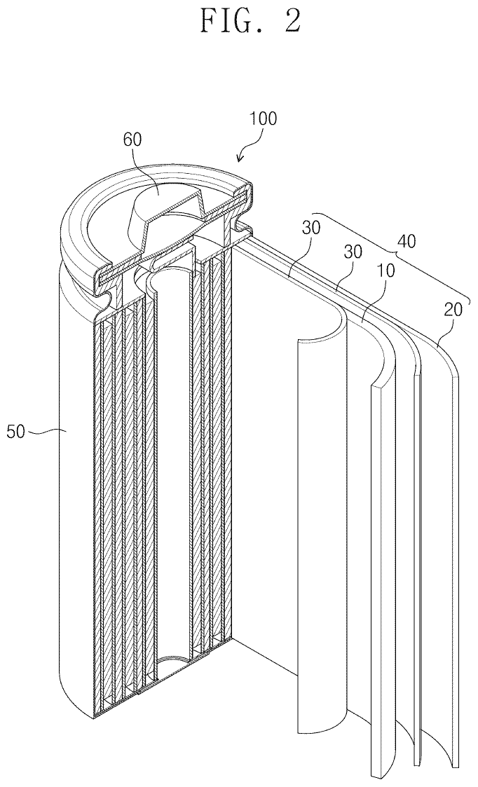

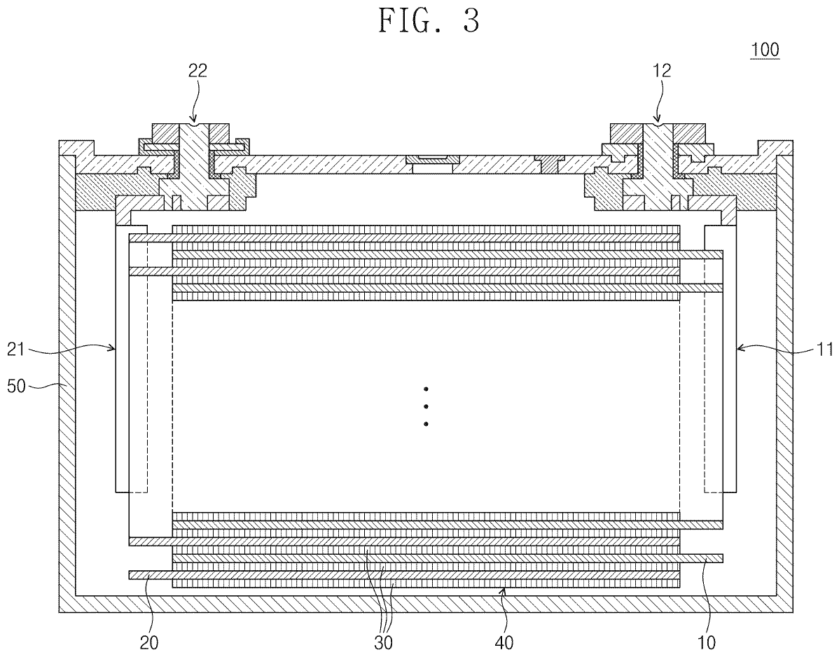

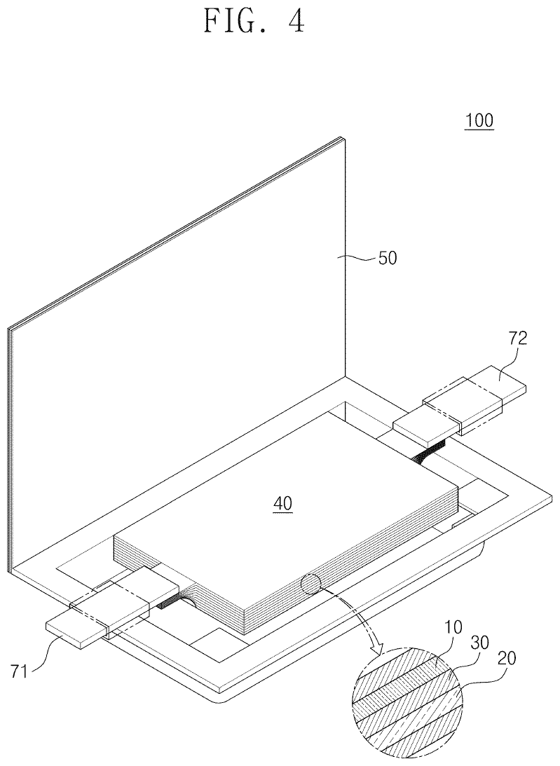

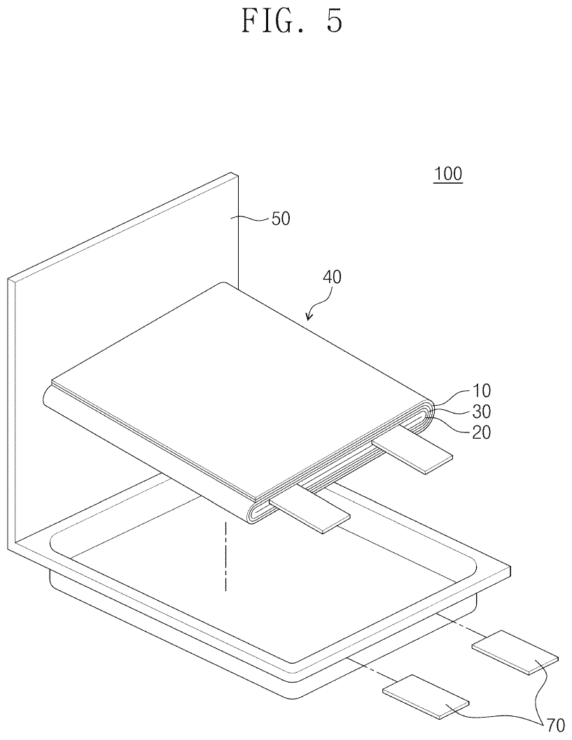

Based on the shape of a rechargeable lithium battery, the rechargeable lithium battery may be classified into cylindrical, prismatic, pouch, or coin types (kinds). In FIGS. 2 to 5 each illustrating a simplified diagram showing a rechargeable lithium battery according to one or more embodiments of the present disclosure, FIG. 2 shows a cylindrical battery, FIG. 3 shows a prismatic battery, and FIGS. 4 and 5 each show a pouch-type or kind battery. Referring to FIGS. 2 to 5, a rechargeable lithium battery 100 may include an electrode assembly 40 in which a separator 30 is interposed between a positive electrode 10 and a negative electrode 20, and may also include a casing 50 in which the electrode assembly 40 is accommodated. The positive electrode 10, the negative electrode 20, and the separator 30 may be impregnated in an electrolyte. In some embodiments, the rechargeable lithium battery 100 may include a sealing member 60 that seals the casing 50 as illustrated in FIG. 2. In some embodiments, as illustrated in FIG. 3, the rechargeable lithium battery 100 may include a positive electrode lead tab 11, a positive electrode terminal 12, a negative electrode lead tab 21, and a negative electrode terminal 22. In some embodiments, as shown in FIGS. 4 and 5, the rechargeable lithium battery 100 may include an electrode tab 70, or a positive electrode tab 71 and a negative electrode tab 72, which serves as an electrical path for externally inducing a current generated in the electrode assembly 40.

A rechargeable lithium battery according to one or more embodiments of the present disclosure may be applied to automotive vehicles, mobile phones, and/or any other electrical devices, but embodiments of the present disclosure are not limited thereto.

The following will describe Embodiments and Comparative Examples of the disclosure. The following example is only one or more embodiments of the disclosure, and embodiments of the disclosure are not limited to the following examples.

### EMBODIMENTS AND COMPARATIVE EXAMPLES

An electrolyte and a rechargeable lithium battery were each fabricated by the following method.

### Embodiment 1

### (1) Preparation of Electrolyte

1.3 M LiPF₆ was dissolved in a non-aqueous organic solvent in which ethylene carbonate (EC), propylene carbonate (PC), and ethyl butyrate (EB) were mixed in a volume ratio of about 10:15:75, and an additive was added to prepare an electrolyte.

The electrolyte was manufactured in which 1 wt % of a compound (a first compound) represented by Chemical 2-1-1 was mixed relative to the total weight of 100 wt % of the electrolyte.

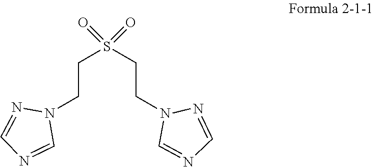 [SMILES: O=S(=O)(CCn1cncn1)CCn1cncn1]

### (2) Fabrication of Rechargeable Lithium Battery

LiCoO₂ as a positive electrode active material, polyvinylidene fluoride as a binder, and acetal black as a conductive material were mixed in a weight ratio of 96:3:1, and the mixture was distributed in n-methyl pyrrolidone to prepare a positive electrode active material slurry.

The positive electrode active material slurry was coated on an Al foil of 15 μum in thickness, dried at 100° C., and then pressed to manufacture a positive electrode.

Artificial graphite as a negative electrode active material, a styrene-butadiene rubber binder, and carboxymethyl cellulose were mixed in a weight ratio of 98:1:1, and the mixture was dispersed in distilled water to prepare a negative electrode active material slurry.

The negative electrode active material slurry was coated on a Cu foil of 10 μm in thickness, dried at 100° C., and then pressed to manufacture a negative electrode.

The positive electrode, the negative electrode, and a polyethylene separator of 10 μm in thickness were assembled to manufacture an electrode assembly, and the electrolyte was introduced to fabricate a rechargeable lithium battery.

### Embodiment 2

An electrolyte and a rechargeable lithium battery were each fabricated by substantially the same method as that of Embodiment 1, except the addition of an additive in which 3 wt % of the first compound was mixed relative to the total weight of 100 wt % of the electrolyte when the electrolyte was prepared.

### Embodiment 3

An electrolyte and a rechargeable lithium battery were each fabricated by substantially the same method as that of Embodiment 1, except the addition of an additive in which 5 wt % of the first compound was mixed relative to the total weight of 100 wt % of the electrolyte when the electrolyte was prepared.

### Embodiment 4

An electrolyte and a rechargeable lithium battery were each fabricated by substantially the same method as that of Embodiment 2, except the use of a non-aqueous organic solvent in which ethylene carbonate (EC), propylene carbonate (PC), and ethyl butyrate (EB) were mixed in a volume ratio of about 10:20:70 when the electrolyte was prepared.

### Embodiment 5

An electrolyte and a rechargeable lithium battery were each fabricated by substantially the same method as that of Embodiment 2, except the use of a non-aqueous organic solvent in which ethylene carbonate (EC), propylene carbonate (PC), and ethyl butyrate (EB) were mixed in a volume ratio of about 10:10:80 when the electrolyte was prepared.

### Embodiment 6

An electrolyte and a rechargeable lithium battery were each fabricated by substantially the same method as that of Embodiment 1, except the use of a non-aqueous organic solvent in which ethylene carbonate (EC), propylene carbonate (PC), and propyl propionate (PP) were mixed in a volume ratio of about 10:15:75 when the electrolyte was prepared.

### Embodiment 7

An electrolyte and a rechargeable lithium battery were each fabricated by substantially the same method as that of Embodiment 1, except the use of a non-aqueous organic solvent in which ethylene carbonate (EC), propylene carbonate (PC), and methyl propionate (MP) were mixed in a volume ratio of about 10:15:75 when the electrolyte was prepared.

### Embodiment 8

An electrolyte and a rechargeable lithium battery were each fabricated by

substantially the same method as that of Embodiment 1, except the use of a non-aqueous organic solvent in which ethylene carbonate (EC), propylene carbonate (PC), and ethyl propionate (EP) were mixed in a volume ratio of about 10:15:75 when the electrolyte was prepared.

### Comparative Example 1

An electrolyte and a rechargeable lithium battery were each fabricated by substantially the same method as that in Embodiment 1, except that no additive is added when the electrolyte was prepared.

### Comparative Example 2

An electrolyte and a rechargeable lithium battery were each fabricated by substantially the same method as that of Embodiment 1, except the preparation of an electrolyte in which 1 wt % of a compound (a second compound) represented by Chemical Formula 3 was mixed relative to the total weight of 100 wt % of the electrolyte when the electrolyte was prepared.

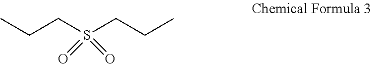

### Evaluation Example: High-temperature Storage Characteristics (Capacity Retention Rate/DC-IR Change Rate)

The rechargeable lithium batteries fabricated according to Embodiments 1 to 8 and Comparative Examples 1 and 2 were each charged and discharged once at 0.2 C to measure charge and discharge capacities (before high-temperature storage).

In addition, the rechargeable lithium batteries fabricated according to Embodiments 1 to 8 and Comparative Examples 1 and 2 were each charged to SOC 100% (i.e., a state charged to 100% of charge capacity when the total charge capacity is set to 100%), stored at 60° C. for 28 days, discharged to 3.0 V at 0.2 C under a constant current condition, and then measured with respect to initial discharge capacity. A ratio of first discharge capacity to the initial discharge capacity was shown as retention capacity.

The rechargeable lithium batteries fabricated according to Embodiments 1 to 8 and Comparative Examples 1 and 2 were each measured with respect to ΔV/ΔI (voltage change/current change) as initial DC-IR, DC-IR were measured by allowing the batteries to change their internal maximum energy states into full-charge states

(SOC 100%), and in this state, the batteries were stored at a high temperature (60° C.) for 28 days to calculate DC-IR increase rates (%) according to Equation 1 and the calculated results are listed in Table 1.

$$DC - IR increase rate = ( DC - IR after 28 days / initial DC - IR ) \times 100 \qquad Equation 1$$

TABLE 1

| | | | | | | | | | High-temperature | |
|---|---|---|---|---|---|---|---|---|---|---|
| | | | | | | | | | storage | |
| | | | | | | | | | characteristics | |
| | | | | | | | Additive | | Capacity | DC-IR |
| | | | | | | | First | Second | retention | increase |
| | Solvent (vol %) | | | | | | compound | compound | rate | rate |
| | EC | PC | EB | PP | MP | EP | (wt %)* | (wt %) | (%) | (%) |
| Embodiment | 10 | 15 | 75 | — | — | — | 1 | —** | 77 | 23 |
| 1 | | | | | | | | | | |
| Embodiment | 10 | 15 | 75 | — | — | — | 3 | — | 82 | 18 |
| 2 | | | | | | | | | | |
| Embodiment | 10 | 15 | 75 | — | — | — | 5 | — | 76 | 22 |
| 3 | | | | | | | | | | |
| Embodiment | 10 | 20 | 70 | — | — | — | 3 | — | 77 | 21 |
| 4 | | | | | | | | | | |
| Embodiment | 10 | 10 | 80 | — | — | — | 3 | — | 76 | 22 |
| 5 | | | | | | | | | | |
| Embodiment | 10 | 15 | — | 75 | — | — | 1 | — | 67 | 30 |
| 6 | | | | | | | | | | |
| Embodiment | 10 | 15 | — | — | 75 | — | 1 | — | 45 | 49 |
| 7 | | | | | | | | | | |
| Embodiment | 10 | 15 | — | — | — | 75 | 1 | — | 53 | 41 |
| 8 | | | | | | | | | | |
| Comparative | 10 | 15 | 75 | — | — | — | — | — | 72 | 25 |
| Example 1 | | | | | | | | | | |
| Comparative | 10 | 15 | 75 | — | — | — | — | 1 | 62 | 35 |
| Example 2 | | | | | | | | | | |

*The unit wt % of the additive is based on the total weight of 100 wt % of the electrolyte.
*The mark of hyphen (—) refers to no addition during the preparation of the electrolyte.

Referring to Table 1, in the cases (Embodiments 1 to 5) where ethyl butyrate (EB) is selected as a solvent and the first compound is chosen as an additive, the capacity retention may be maintained and the resistance increase rate may not be high compared to the case (Comparative Example 1) where an electrolyte containing no additive is used.

In the cases (Embodiment 1 and Comparative Example 2) whose additive amounts (e.g., concentrations) are the same, even though a sulfone-based additive is employed, the capacity retention rate may be improved and the resistance increase rate may not be high in the case (Embodiment 1) where the first compound is chosen as an additive compared to the case (Comparative Example 2) where the second compound is selected as an additive.

In the cases (Embodiments 2, 4, and 5) having the same amount of the first compound, if (e.g., when) a solvent of ethyl butyrate (EB) has an amount of about 75 vol %, the resistance increase rate may have a minimum value and the capacity retention rate may have a maximum value.

A rechargeable lithium battery including an electrolyte according to one or more embodiments may have excellent or suitable high-temperature characteristics at a high-voltage environment.

In the present disclosure, expressions such as “at least one of,” “one of,” and “selected from,” when preceding a list of elements, modify the entire list of elements and do not modify the individual elements of the list. For example, “at least one of a, b or c”, “at least one selected from a, b, and c”, “at least one selected from among a to c”, etc., may indicate only a, only b, only c, both (e.g., simultaneously) a and b, both (e.g., simultaneously) a and c, both (e.g., simultaneously) b and c, all of a, b, and c, or variations thereof. The “/” utilized herein may be interpreted as “and” or as “or” depending on the situation.

In the context of the present disclosure and unless otherwise defined, the terms “use,” “using,” and “used” may be considered synonymous with the terms “utilize,” “utilizing,” and “utilized,” respectively.

In present disclosure, The term “Group” as utilized herein refers to a group of the Periodic Table of Elements according to the 1 to 18 grouping system of the International Union of Pure and Applied Chemistry (“IUPAC”).

As used herein, the terms “substantially,” “about,” and similar terms are used as terms of approximation and not as terms of degree, and are intended to account for the inherent deviations in measured or calculated values that would be recognized by those of ordinary skill in the art. “About” or “approximately,” as used herein, is also inclusive of the stated value and means within an acceptable range of deviation for the particular value as determined by one of ordinary skill in the art, considering the measurement in question and the error associated with measurement of the particular quantity (i.e., the limitations of the measurement system). For example, “about” may mean within one or more standard deviations, or within ±30%, 20%, 10%, or 5% of the stated value.

Any numerical range recited herein is intended to include all sub-ranges of the same numerical precision subsumed within the recited range. For example, a range of “1.0 to 10.0” is intended to include all subranges between (and including) the recited minimum value of 1.0 and the recited maximum value of 10.0, that is, having a minimum value equal to or greater than 1.0 and a maximum value equal to or less than 10.0, such as, for example, 2.4 to 7.6. Any maximum numerical limitation recited herein is intended to include all lower numerical limitations subsumed therein and any minimum numerical limitation recited in this specification is intended to include all higher numerical limitations subsumed therein. Accordingly, Applicant reserves the right to amend this specification, including the claims, to expressly recite any sub-range subsumed within the ranges expressly recited herein.

A battery management system (BMS) device, and/or any other relevant devices or components according to embodiments of the present invention described herein may be implemented utilizing any suitable hardware, firmware (e.g., an application-specific integrated circuit), software, or a combination of software, firmware, and hardware. For example, the various components of the device may be formed on one integrated circuit (IC) chip or on separate IC chips. Further, the various components of the device may be implemented on a flexible printed circuit film, a tape carrier package (TCP), a printed circuit board (PCB), or formed on one substrate. Further, the various components of the device may be a process or thread, running on one or more processors, in one or more computing devices, executing computer program instructions and interacting with other system components for performing the various functionalities described herein. The computer program instructions are stored in a memory which may be implemented in a computing device using a standard memory device, such as, for example, a random access memory (RAM). The computer program instructions may also be stored in other non-transitory computer readable media such as, for example, a CD-ROM, flash drive, or the like. Also, a person of skill in the art should recognize that the functionality of various computing devices may be combined or integrated into a single computing device, or the functionality of a particular computing device may be distributed across one or more other computing devices without departing from the scope of the present disclosure.

A person of ordinary skill in the art would appreciate, in view of the present disclosure in its entirety, that each suitable feature of the various embodiments of the present disclosure may be combined or combined with each other, partially or entirely, and may be technically interlocked and operated in various suitable ways, and each embodiment may be implemented independently of each other or in conjunction with each other in any suitable manner unless otherwise stated or implied.

While the present disclosure has been described in connection with what is presently considered to be example embodiments, it is to be understood that the present disclosure is not limited to the disclosed embodiments and is intended to cover one or more suitable modifications and equivalent arrangements included within the spirit and scope of the appended claims and equivalents thereof, and therefore the aforementioned embodiments should be understood to be exemplarily but not limiting this disclosure in any way.

What is claimed is:

1. An electrolyte, the electrolyte comprising:
a lithium salt;
a non-aqueous organic solvent; and
an additive,
wherein the non-aqueous organic solvent comprises a compound represented by Chemical Formula 1,
wherein the additive comprises a compound represented by Chemical Formula 2, 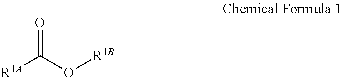
in Chemical Formula 1,
R^{1A} and R^{1B} being each independently hydrogen, a halogen, a substituted or unsubstituted C1 to C10 alkyl group, or a substituted or unsubstituted C3 to C10 cycloalkyl group, 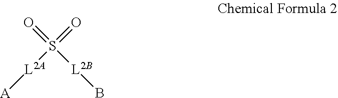
in Chemical Formula 2,
L^{2A} and L^{2B} being each independently a single bond, a substituted or unsubstituted C1 to C5 alkylene group, a substituted or unsubstituted C2 to C5 alkenylene group, a substituted or unsubstituted C2 to C5 alkynylene group, or a substituted or unsubstituted C6 to C20 arylene group,
A and B being each independently a substituted or unsubstituted C1 to C20 alkyl group, a substituted or unsubstituted C6 to C20 aryl group, or a substituted or unsubstituted C2 to C20 heteroaryl group, and
at least one selected from among A and B being a group represented by Chemical Formula A, 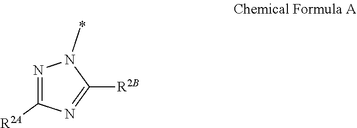
in Chemical Formula A,
R^{2A} and R^{2B} being each independently hydrogen, a halogen, a substituted or unsubstituted C1 to C10 alkyl group, or a substituted or unsubstituted C3 to C10 cycloalkyl group, and
wherein the electrolyte is for a rechargeable lithium battery.

2. The electrolyte as claimed in claim 1, wherein R^{1A} is a substituted or unsubstituted C3 to C10 alkyl group.

3. The electrolyte as claimed in claim 1, wherein R^{1A} is a substituted or unsubstituted C3 alkyl group.

4. The electrolyte as claimed in claim 1, wherein R^{1A} is an unsubstituted C3 alkyl group.

5. The electrolyte as claimed in claim 1, wherein the compound represented by Chemical Formula 1 comprises at least one selected from among methyl butyrate, ethyl butyrate, and propyl butyrate.

6. The electrolyte of claim 1, wherein the compound represented by Chemical Formula 1 is in an amount of about 50 vol % to about 95 vol % relative to a total volume of 100 vol % of the electrolyte.

7. The electrolyte as claimed in claim 1, wherein the non-aqueous organic solvent further comprises a carbonate-based solvent.

8. The electrolyte as claimed in claim 1, wherein at least one selected from among L^{2A} and L^{2B} is a substituted or unsubstituted C1 to C5 alkylene group.

9. The electrolyte as claimed in claim 1, wherein at least one selected from among L^{2A} and L^{2B} is a substituted or unsubstituted C2 to C5 alkylene group.

10. The electrolyte as claimed in claim 1, wherein the compound represented by Chemical Formula 2 is represented by Chemical Formula 2-1, 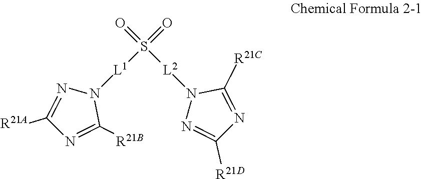
in Chemical Formula 2-1,
L¹ and L² being each independently a substituted or unsubstituted C2 to C5 alkylene group, and
R^{21A}, R^{21B}, R^{21C}, and R^{21D} being each independently hydrogen, a halogen, a substituted or unsubstituted C1 to C10 alkyl group, or a substituted or unsubstituted C3 to C10 cycloalkyl group.

11. The electrolyte as claimed in claim 1, wherein the compound represented by Chemical Formula 2 comprises at least one selected from among compounds listed in Group 1,

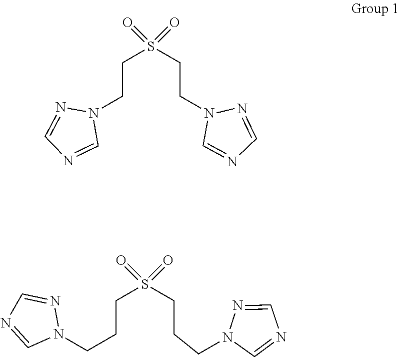 [SMILES: O=S(=O)(CCn1cncn1)CCn1cncn1 ; O=S(=O)(CCCn1cncn1)CCCn1cncn1]

12. The electrolyte as claimed in claim 1, wherein the compound represented by Chemical Formula 2 is in an amount of about 0.1 to 10 parts by weight relative to a total 100 parts by weight of the electrolyte.

13. The electrolyte as claimed in claim 1, wherein the additive further comprises at least one selected from among vinylene carbonate, fluoroethylene carbonate, difluoroethylene carbonate, chloroethylene carbonate, dichloroethylene carbonate, bromoethylene carbonate, dibromoethylene carbonate, nitroethylene carbonate, cyanoethylene carbonate, vinylethylene carbonate, adiponitrile, succinonitrile, 1,3,6-hexane tricyanide, propenesultone, propanesultone, lithium tetrafluoroborate, lithium difluorophosphate, and 2-fluoro biphenyl.

14. The electrolyte as claimed in claim 1, wherein the additive is in an amount of about 0.1 to 30 parts by weight relative to a total 100 parts by weight of the electrolyte.

15. The electrolyte as claimed in claim 1, wherein the lithium salt comprises LiPF₆.

16. A rechargeable lithium battery, comprising:
a positive electrode that comprises a positive electrode active material;
a negative electrode that comprises a negative electrode active material; and
the electrolyte as claimed in claim 1.

17. The rechargeable lithium battery as claimed in claim 16, wherein the positive electrode active material comprises a lithium nickel-based oxide, a lithium cobalt-based oxide, a lithium manganese-based oxide, a lithium iron phosphate-based compounds, a cobalt-free nickel-manganese-based oxide, or a combination thereof.

18. The rechargeable lithium battery as claimed in claim 16, wherein the negative electrode active material comprises a carbon-based negative electrode active material, a silicon-based negative electrode active material, or a combination thereof.

19. The rechargeable lithium battery as claimed in claim 16, wherein the rechargeable lithium battery is a pouch-type battery.
